(19) United States
(12) Patent Application Publication
(10) Pub. No.: US 2017/0259880 A1
(43) Pub. Date: Sep. 14, 2017

(54) Crankset

(71) Applicant: GATES CORPORATION, Denver, CO (US)

(72) Inventors: Ryan Osborn, Denver, CO (US); Mark A. Chapman, Englewood, CO (US)

(21) Appl. No.: 15/067,402

(22) Filed: Mar. 11, 2016

(51) Int. Cl. B62M 9/02; B62M 1/36

(52) U.S. Cl. CPC B62M 9/02; B62M 1/36

(57) ABSTRACT

A crankset for a bicycle comprising a shaft rotationally engaged with a bicycle frame, the shaft having a radially extending flange disposed toward one end, a first crank arm and a second crank arm, and each connected to an opposing end of the shaft and being approximately 180 degrees out of phase with each other, a first sprocket keyed to the shaft, the first sprocket having a toothed belt engaging surface, and a spacer member disposed between the first sprocket and the flange for adjusting a first sprocket position.

### FIELD OF THE INVENTION

The invention relates to a crankset, and more particularly, to a crankset having a spacer member for adjusting a first sprocket position with respect to a second sprocket.

### BACKGROUND OF THE INVENTION

Belt drives are gaining wide popularity on bicycles. However, to operate properly belt drives require proper alignment between the front sprocket and the rear sprocket. Achieving proper alignment of the sprockets by reliance on control of frame tolerances can increase production costs. Additionally, different internally geared hubs require different belt lines between the front and rear sprockets, but the rear sprocket position is non-adjustable which then requires changes to the frame design to accommodate the front sprocket.

Representative of the art is U.S. Pat. No. 8,905,878 which discloses a bicycle sprocket assembly is provided with at least a first sprocket and a first axial spacer. The first sprocket includes a first sprocket mounting portion, a plurality of first sprocket arms extending radially from the first sprocket mounting portion and a first chain engaging portion disposed on radial outer ends of the first sprocket arms. The first chain engaging portion includes a plurality of first teeth. The first axial spacer is disposed on a first sprocket side surface of the first sprocket. The first axial spacer has a first spacer mounting portion and a plurality of first spacer arms extending radially from the first spacer mounting portion. The first spacer arms are partially visible from an axial view of a second sprocket side surface that faces in an opposite direction from the first sprocket side surface.

What is needed is a crankset having a spacer member disposed between a first sprocket and a flange for adjusting a first sprocket position. The present invention meets this need.

### SUMMARY OF THE INVENTION

An aspect of the invention is to provide a crankset having a spacer member disposed between a first sprocket and a flange for adjusting a first sprocket position.

Other aspects of the invention will be pointed out or made obvious by the following description of the invention and the accompanying drawings.

The invention comprises a crankset for a bicycle comprising a shaft rotationally engaged with a bicycle frame, the shaft having a radially extending flange disposed toward one end, a first crank arm and a second crank arm, and each connected to an opposing end of the shaft and being approximately 180 degrees out of phase with each other, a first sprocket keyed to the shaft, the first sprocket having a toothed belt engaging surface, and a spacer member disposed between the first sprocket and the flange for adjusting a first sprocket position.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of a bicycle frame with the invention.

FIG. 2 is an exploded view of the invention and bicycle frame.

FIG. 3 is an exploded view of the invention.

FIG. 4 is a perspective view of the invention.

FIG. 5 is a detail of FIG. 4.

FIG. 6 is a cross sectional view of the invention on a bicycle frame.

FIG. 7 is a top view of the invention in a bicycle frame.

FIG. 8 is a perspective view of a rear sprocket.

### DETAILED DESCRIPTION OF THE PREFERRED EMBODIMENT

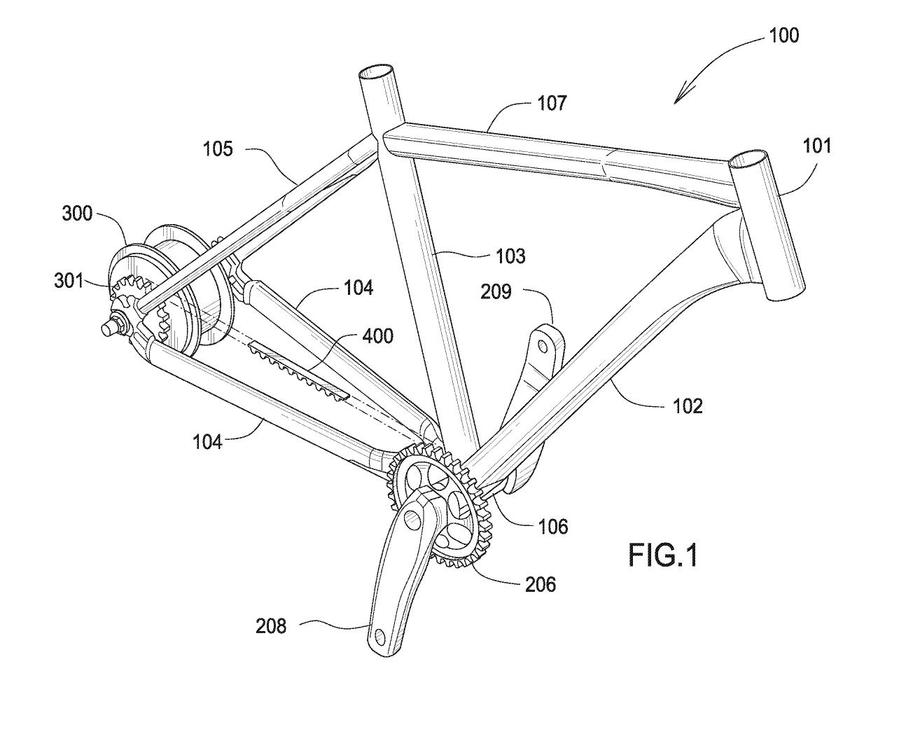

FIG. 1 is a perspective view of a bicycle frame with the invention. Frame 100 comprises a head tube 101, down tube 102, seat tube 103, chain stays 104, seat stays 105, bottom bracket shell 106 and top tube 107.

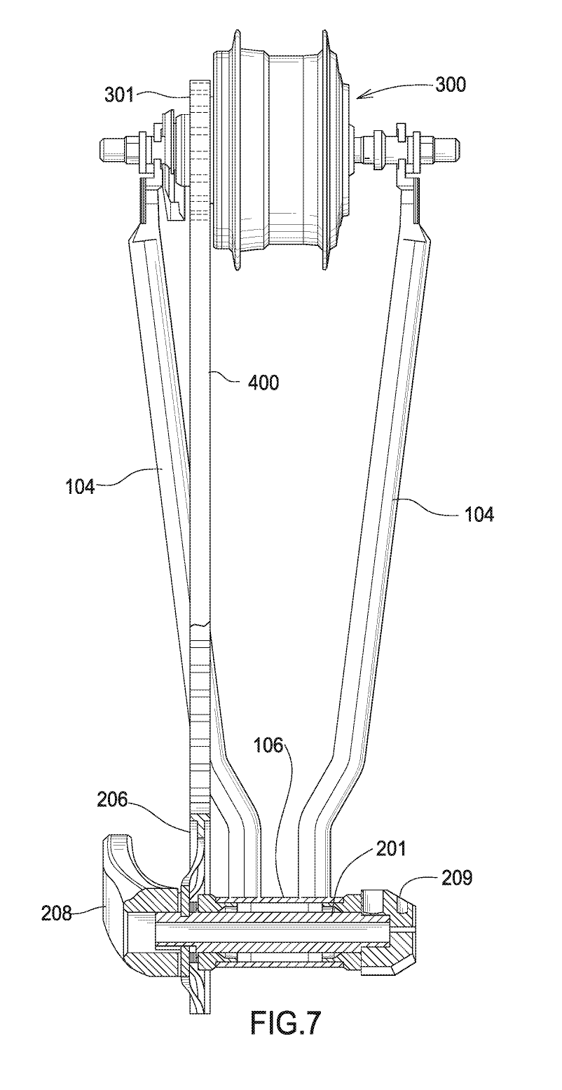

The inventive crankset is installed in the bottom bracket shell 106. A rear hub 300 may comprise a single gear or multi-gear hub. A toothed belt (FIG. 7) is trained between the rear sprocket 301 and front sprocket 206.

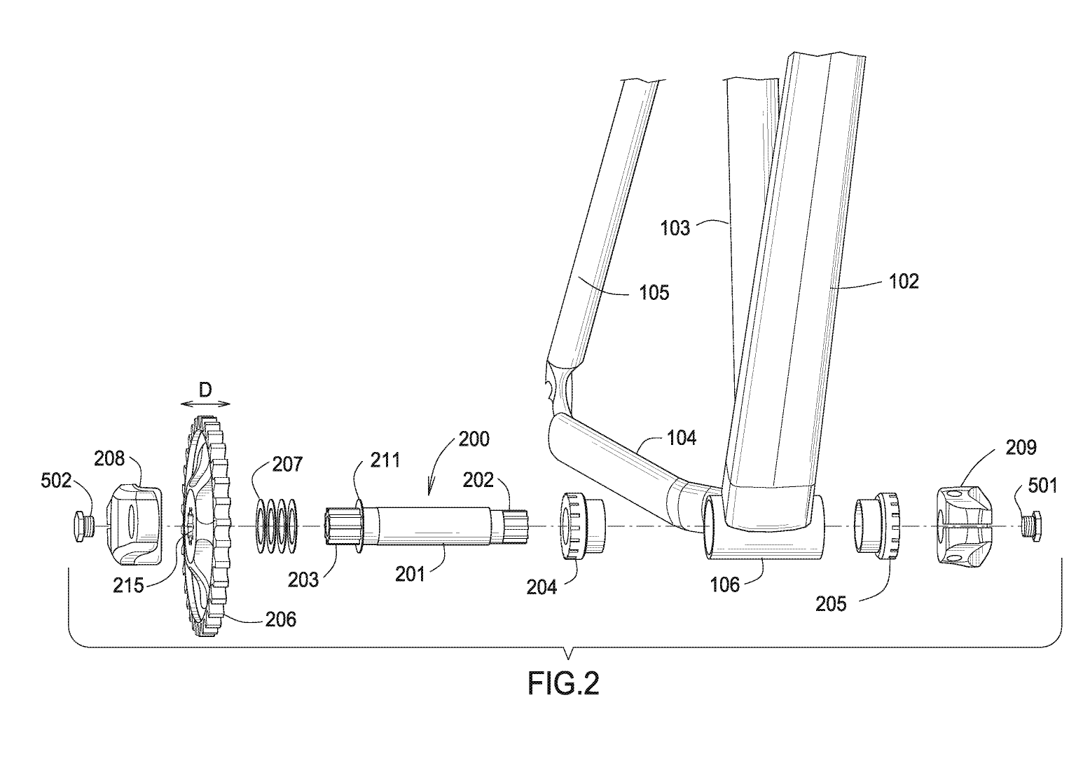

FIG. 2 is an exploded view of the invention and bicycle frame. The crankset comprises shaft 201, bottom bracket cups 204, 205, spacer members 207, crank arm 208 and crank arm 209. Shaft 201 comprises a radially extending flange 211 disposed at one end of the shaft. Spacer members 207 bear against flange 211. Each end 202, 203, of shaft 201 is fluted, keyed or otherwise axially shaped to mechanically engage with the respective crank arm 209, 208. The crank arms are approximately 180 degrees out of phase with each other. Each crank arm is affixed to the end of the shaft 201 via a bolt 501 and 502 respectively, or other known fastening system such as a cotter pin, retaining ring, set screw and so on. Bolt 501 also provides proper bearing tension for each of the bearing cup surfaces.

Spacer members 207 are annular in shape and are disposed between sprocket 206 and flange 211 on shaft 201. Spacer members 207 are used to axially locate sprocket 206. One or more spacer members 207 are used to properly align sprocket 206 with respect to the rear sprocket 301 so that the belt is properly aligned between the sprockets.

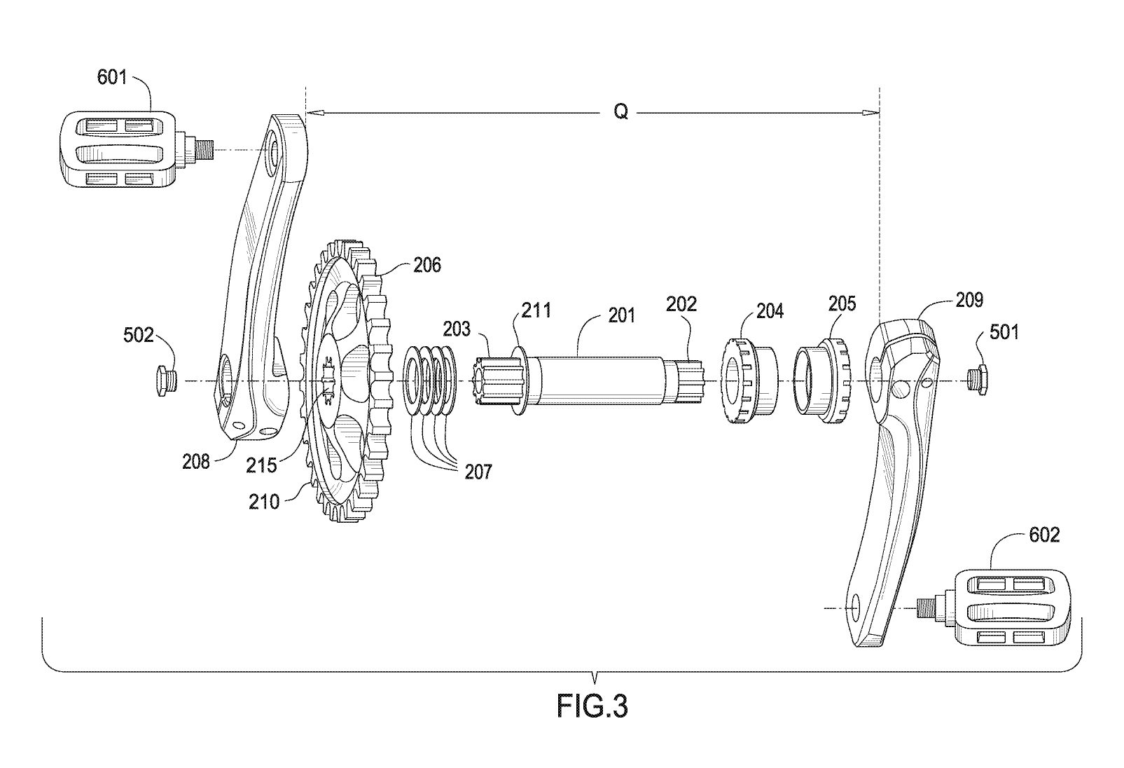

FIG. 3 is an exploded view of the invention. A center portion 215 of sprocket 206 is fluted, keyed or otherwise axially shaped to mechanically engage shaft end 203. Each cup 204, 205 is threaded to engage bottom bracket shell 106. A pedal 601, 602 can be attached to each crank arm as is known in the art.

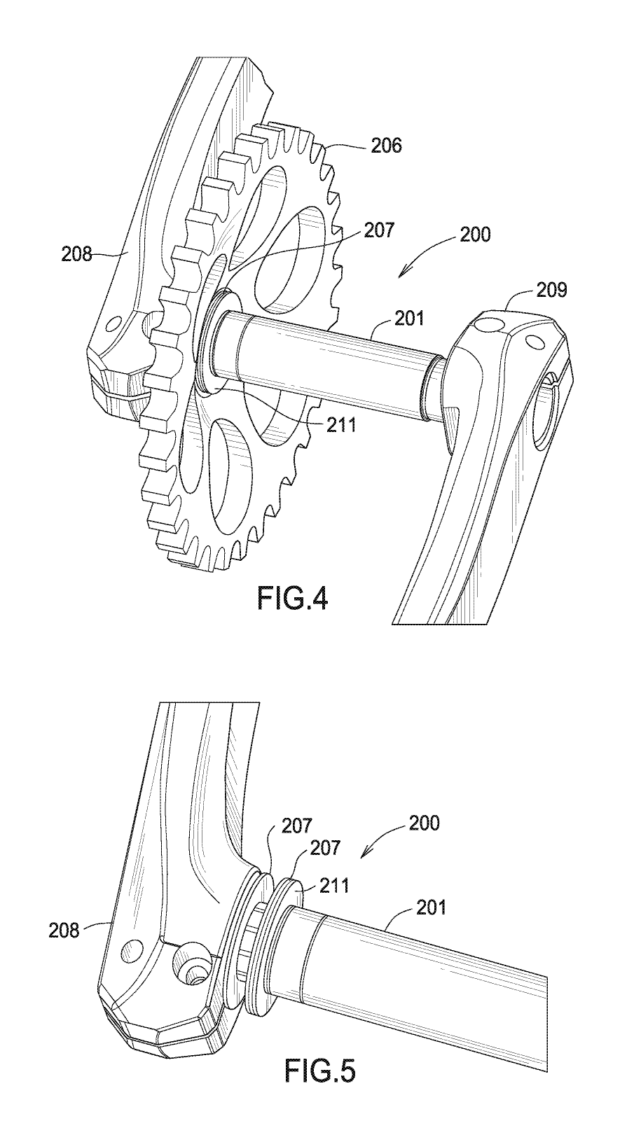

FIG. 4 is a perspective view of the invention. Spacer members 207 may be approximately 1 mm in thickness, although any appropriate thickness can be selected to achieve the desired position of sprocket 206 in relation to the rear sprocket 301.

Spacing of the sprocket also can affect the Q-factor of the crankset. The Q-factor of a bicycle is the distance (Q, see FIG. 3) between the pedal attachment points on the crank arms 208, 209 when measured parallel to the bottom bracket shaft 201. One or more spacer members 207 can be used to adjust the Q-factor of the bicycle if desired by a user. This is accomplished by placing one or more spacer members 207 between the crank arm 208 and sprocket 206, or between the sprocket 206 and the flange 211. Proper adjustment of the Q-factor can have a significant effect on a rider's comfort. The invention also allows alignment of front sprocket 206 with rear sprocket 301 without affecting Q-factor, or requiring offset spacing of the entire crankset.

FIG. 5 is a detail of FIG. 4. Spacer members 207 may be placed on either side of sprocket 206 to achieve the desired position. Sprocket 206 is clamped between crank arm 208 and flange 211. Flange 211 may be an integral part of the shaft 201, or may comprise a shoulder of slightly larger radius than the shaft; it may also be threaded on or a snap ring. The flange may be used with all bottom brackets known in the art such as threaded, PF30 and T47.

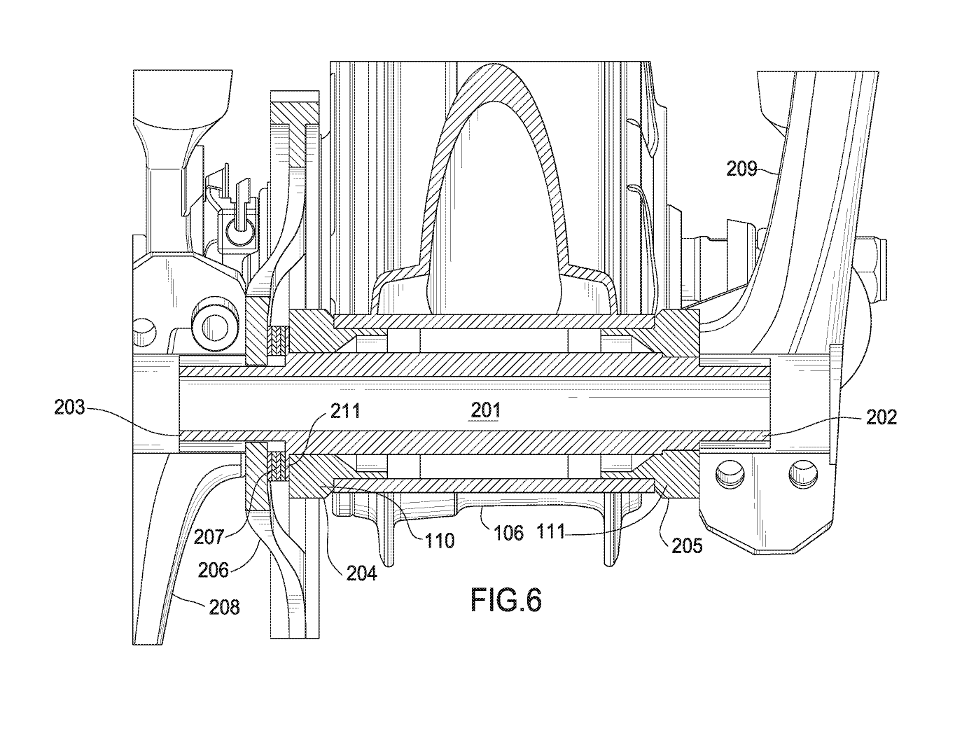

FIG. 6 is a cross sectional view of the invention on a bicycle frame. Shaft 201 rotates in bearings 110, 111. Bearings 110, 111 are contained in cups 204, 205 respectively.

FIG. 7 is a top view of the invention in a bicycle frame. A toothed belt 400 is trained between sprocket 206 and sprocket 301. Spacer members 207 are used to allow proper alignment of sprocket 206 with sprocket 301. This assures proper tracking and engagement of toothed belt 400 with the sprockets during operation.

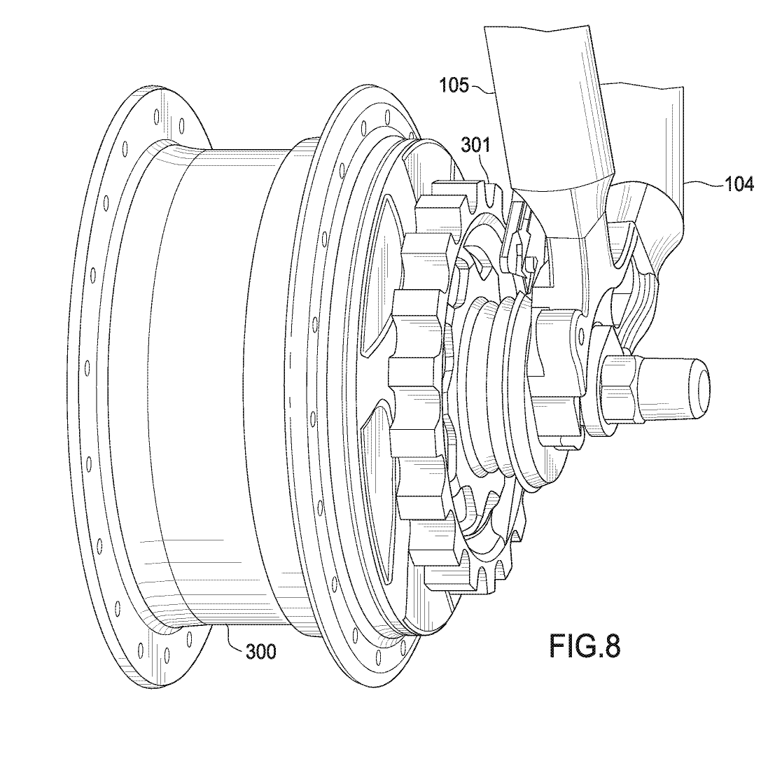

FIG. 8 is a perspective view of a rear sprocket. Rear sprocket 301 is connected to a rear hub 300. Rear hub 300 may comprise a single speed hub or an internally geared multi-speed hub, or other common hub type known in the art.

Although a form of the invention has been described herein, it will be obvious to those skilled in the art that variations may be made in the construction and relation of parts without departing from the spirit and scope of the invention described herein.

We claim:

1. A crankset for a bicycle comprising:
a shaft rotationally engaged with a bicycle frame, the shaft having a radially extending flange disposed toward one end;
a first crank arm and a second crank arm, and each connected to an opposing end of the shaft and being approximately 180 degrees out of phase with each other;
a first sprocket keyed to the shaft, the first sprocket having a toothed belt engaging surface; and
a spacer member disposed between the first sprocket and the flange for adjusting a first sprocket position.

2. The crankset as in claim 1 further comprising:
a second sprocket, and
a toothed belt trained between the first sprocket and the second sprocket.

3. The crankset as in claim 1 wherein the second sprocket is rotationally engaged with the bicycle frame.

4. The crankset as in claim 1 further comprising two or more spacer members between the first sprocket and the flange.

5. The crankset as in claim 1 further comprising:
one or more spacer members disposed between the first crank arm and the first sprocket wherein the distance between the first crank arm and the second crank arm is adjustable.

6. A crankset for a bicycle comprising:
a shaft rotationally engaged with a bicycle frame by one or more bearings, the shaft having a radially extending flange disposed toward one end of the shaft;
a first crank arm and a second crank arm and each connected to an opposing end of the shaft and being approximately 180 degrees out of phase with each other;
a first sprocket keyed to the shaft, the first sprocket having a toothed belt engaging surface;
a pedal attached to the first crank arm and a second pedal attached to the second crank arm; and
one or more spacer members disposed between the first sprocket and the flange for adjusting a first sprocket position.

7. A bicycle comprising:
a frame having a bottom bracket;
a shaft rotationally engaged with the bottom bracket by one or more bearings, the shaft having a radially extending flange disposed toward one end of the shaft;
a first crank arm and a second crank arm and each connected to an opposing end of the shaft and being approximately 180 degrees out of phase with each other;
a first sprocket keyed to the shaft, the first sprocket having a toothed belt engaging surface;
a second sprocket engaged with the frame;
a pedal attached to the first crank arm and a second pedal attached to the second crank arm;
one or more spacer members disposed between the first sprocket and the flange for adjusting a first sprocket position relative to the second sprocket; and
a toothed belt trained between the first sprocket and the second sprocket.
